(19) United States
(12) Patent Application Publication
(10) Pub. No.: US 2004/0006903 A1
(43) Pub. Date: Jan. 15, 2004

(54) Manipulable foam mat with magnetic backing

(76) Inventor: Michael Haytas, Lakewood, OH (US)

Correspondence Address: Richard M. Klein, Fay Sharpe et al., Seventh Floor, 1100 Superior Avenue, Cleveland, OH, 44114, US

(21) Appl. No.: 10/619,309

(22) Filed: Jul. 14, 2003

Related U.S. Application Data
(60) Provisional application No. 60/395,598, filed on Jul. 12, 2002.

(51) Int. Cl. G09F 7/04

(52) U.S. Cl. 40/600; 40/621

(57) ABSTRACT

A decorative display system having a foam mat with a magnetic backing is provided. The display system includes a resilient foam material that is bonded to a rubberized magnetic sheet. The display system is flexible and readily accepts adhesives and paints used to create personalized designs by a home user. A method of manufacturing a foam mat with a magnetic backing is also provided.

### FIELD OF THE INVENTION

The present invention relates to the art of decorative magnets. More particularly, the present invention relates to a decorative display system having a manipulable foam mat with a magnetic backing that can be individually shaped, configured and decorated by a home user.

### BACKGROUND OF THE INVENTION

Magnets with logos or decorations are known in the art. Moreover, there are magnets that are flexible and include top surfaces of plastic upon which designs are sometimes molded or commercially printed.

The magnets of the prior art, however, do not allow a consumer to individually create a design that may be personalized. Because magnets are often used in homes and personal areas, such customization would be advantageous.

As a result, it is desirable to develop a magnet that can be readily decorated and personalized by a home consumer.

### BRIEF SUMMARY OF THE INVENTION

In an exemplary embodiment of the present invention, a decorative display system having a foam mat with a magnetic backing is provided. The mat includes a resilient foam material that is bonded to a rubberized magnetic sheet. The mat is flexible and readily accepts adhesives and paints used to create personalized designs by a home user.

In another exemplary embodiment of the present invention, a flexible magnet is provided. The mat includes a resilient foam material that is bonded by an adhesive to a rubberized magnetic sheet. The mat can readily be cut, shaped and configured to a desired size and configuration by a home user. There are other objects and features of the invention, which will be apparent from the following description and claims.

### BRIEF DESCRIPTION OF THE DRAWINGS

The following is a brief description of the drawings, which are presented for the purpose of illustrating the invention and not for the purpose of limiting the same, and wherein:

FIG. 1 is a side view of one embodiment of a decorative display system of the invention;

FIG. 2 is a perspective view of the decorative display system of FIG. 1;

FIG. 3 is a top view of decorative display system of FIG. 1;

FIG. 4 is an example of a use of a foam mat with magnetic backing of the invention; and

FIG. 5 is another example of a use of a foam mat with magnetic backing of the invention.

### DETAILED DESCRIPTION OF THE INVENTION

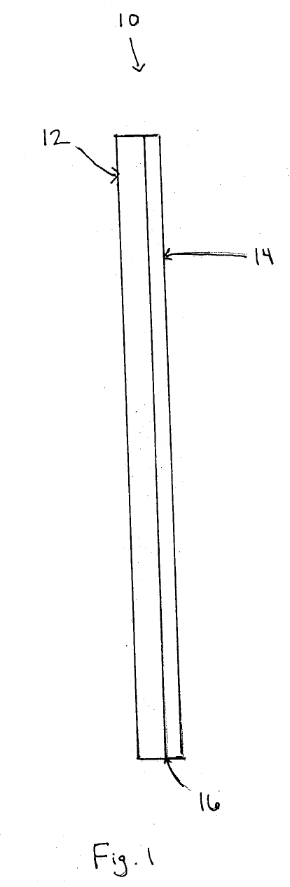

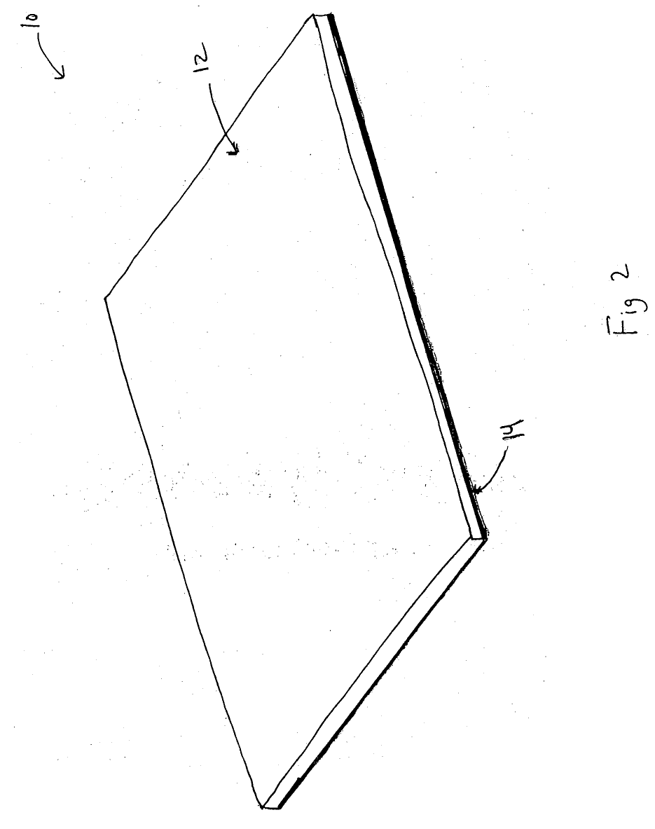

Referring now to the drawings, wherein the showings are for purposes of illustrating preferred embodiments of the invention and not for the purpose of limiting the same, FIG. 1 illustrates a side view and FIG. 2 illustrates a perspective view of a decorative display system 10 according to the present invention, comprising a manipulable foam mat 12 which is adhered to a magnetic sheet 14 at interface 16. The manipulable foam mat 12 has a first surface and a second surface. The magnetic sheet 14 has a first surface and a second surface at least one of which is magnetized. To form the decorative display system 10, a surface of the magnetic sheet 14 is adhered to a surface of the foam mat 12. If only one surface of the magnetic sheet is magnetized, the non-magnetized surface is the surface that is adhered to a surface of the foam mat. The combination of the manipulable foam mat and the magnetic sheet provides a manipulable decorative display system having an exposed foam surface and a magnetic backing. The exposed surface of the manipulable foam mat 12 provides a surface which is substantially free of any markings and/or pre-printed designs, upon which an end user is free to decorate the surface as desired. The exposed surface of the magnetic sheet 14 provides a magnetic surface that allows the manipulable decorative display system to be placed on any ferrous surface for display.

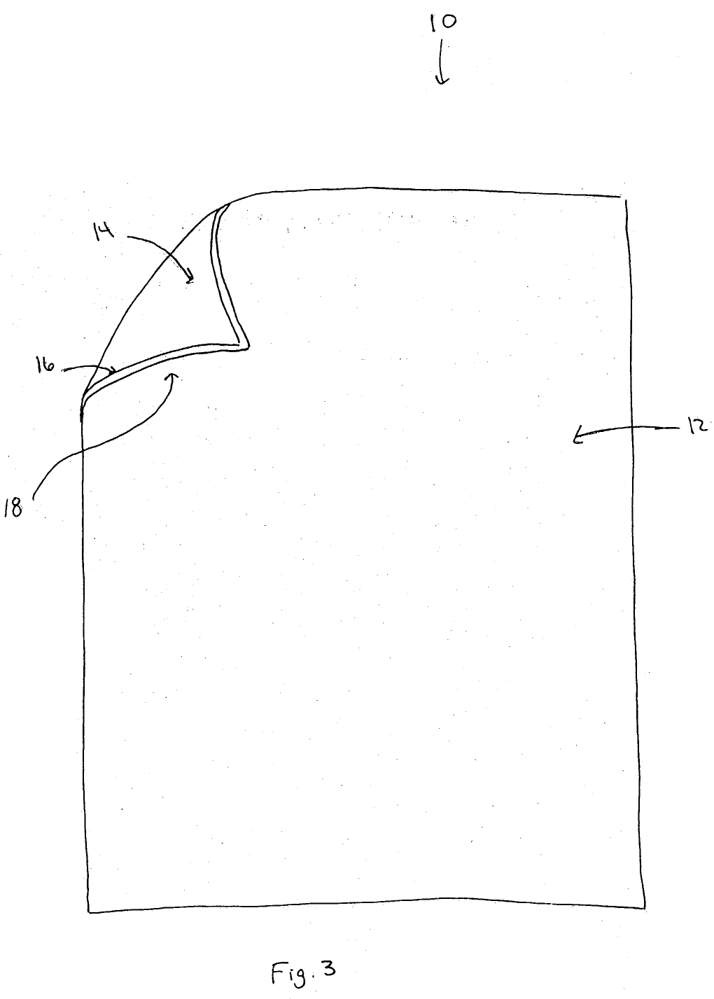

With reference to FIG. 3, the composition of the assembled display system 10 is shown. The top foam surface 12 is bonded to the magnetic backing 14 by an adhesive (not shown) at an interface 16. The adhesive may be any glue known in the art that creates a strong bond between the top foam surface 12 and the adhesive backing 14. The flexibility of the assembled display system 10 is illustrated by the bending of a corner area 18 substantially over a portion of the remainder of the mat 10.

The manipulable foam mat 10, which is the side that the consumer sees when the product is in use, is of a resilient, yet pliable, foam material, such as EVA (ethyl vinyl acetate) foam. The resiliency of the foam material leads to structural stability of the assembled display 10, thereby allowing a user to handle the display 10 as well as to apply decorations to it.

The pliability of the foam mat 12 allows the assembled display 10 to flex and respond to a consumer's manipulation, thereby facilitating ready customization. The foam mat 12 readily accepts adhesives used in the art of home crafts, such as hot glue (a urethane adhesive that is melted for application) as well as adhesives that are used on decorative stickers. The foam mat 12 also accepts paint, ink, stickers and other decorative means used in the home-craft art.

The foam mat 12 may be of a thickness in a range of about 0.5 millimeters (mm) to about 5.0 mm. Preferably, the foam mat 10 is of a thickness of about 2.0 mm.

The magnetic backing 14 is a rubberized sheet containing magnetic particles from the class of hard magnetic materials, i.e., materials that retain magnetic properties when removed from a magnetic field, also known as permanent magnets. The composition of the rubberized sheet of the magnetic backing 14 may be a synthetic rubber that is compounded with a magnetic metal powder, which is then produced in sheet form.

The magnetic backing 14 is of a thickness in a range of from about 0.1 mm to about 0.5 mm. Preferably, the magnetic backing is of a thickness in a range of from about 0.2 mm to about 0.3 mm. This combination of thickness and the rubberized sheet nature of the backing 14 allow it to add stability to the foam top surface 12 (referring back to FIG. 1) while maintaining flexibility and responsiveness to customization by a user.

When the assembled display 10 is in a form that the user deems ready for display, the magnetic backing 14 enables the decoration to be placed on a ferrous surface and held for display by the magnetic attraction of the backing 14 to the ferrous surface. Such ferrous surfaces may include, but are not limited to vehicle panels, pre-fabricated homes, trailers and home appliances such as refrigerators, dishwashers and the like.

As mentioned above, the assembled display system 10 is suitable for decorating and customization by a home user, including cutting of the display system 10. The low thickness and shear-able nature of the foam top surface 10 and the magnetic backing 14 allow the mat 12 to be readily cut to a desired size with a scissors or other means available to a typical home user.

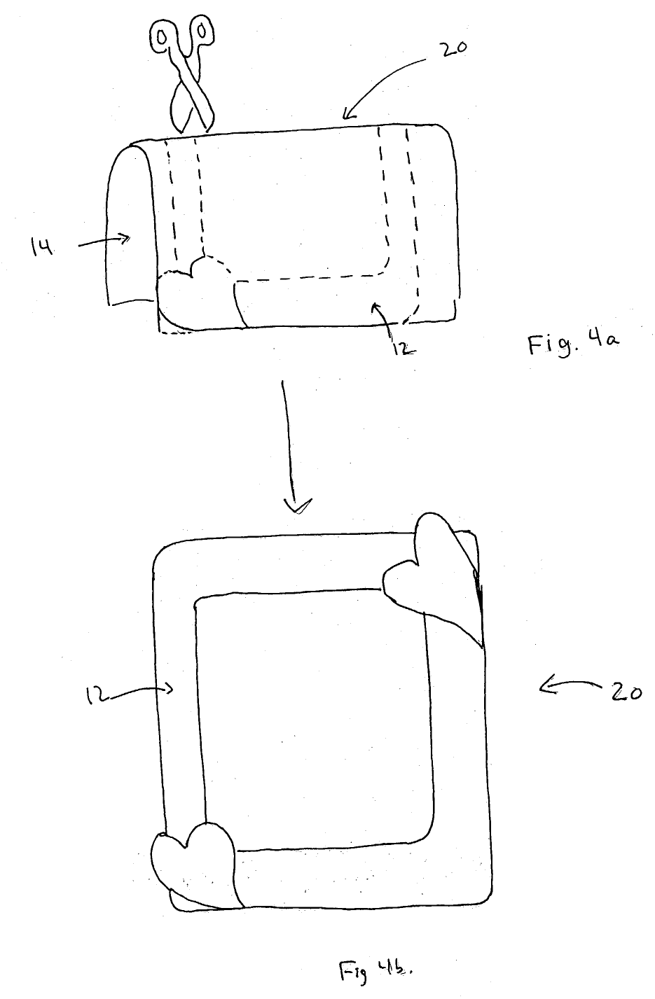

An example of the ability of the display system 10 to be customized is illustrated in FIG. 4. FIG. 4 illustrates a situation wherein a user may create a magnetic picture frame 28 from the decorative display system of the present invention. In FIG. 4a, the user has marked a desired frame shape on the foam surface 12 of the display system as evidenced by the dashed lines. The user may prepare the desired end product by cutting along the dashed lines.

FIG. 4a demonstrates the ease with which an opening for a frame may be created. In FIG. 4a, the display system 10 has been manipulated by bending the system, such that a user may cut at a folded portion 20 to create an opening for a frame. FIG. 4b illustrates the user's end product, a frame having a foam surface 12 and magnetic backings 14 (not shown). As is apparent from FIG. 4, the decorative display system according to the present invention allows a user to customize and create a display in any desired shape. It is also appreciated that the end user may further customize the display by painting, drawing or affixing other decorative items, such as stickers or personalized cut outs by gluing to the display created from the decorative display system of the invention.

A frame that is produced from the present invention, such as that illustrated in FIG. 4, allows the user to display a picture within the frame by placing the frame around a picture and then placing on a ferrous surface. The frame then retains the picture on the ferrous surface.

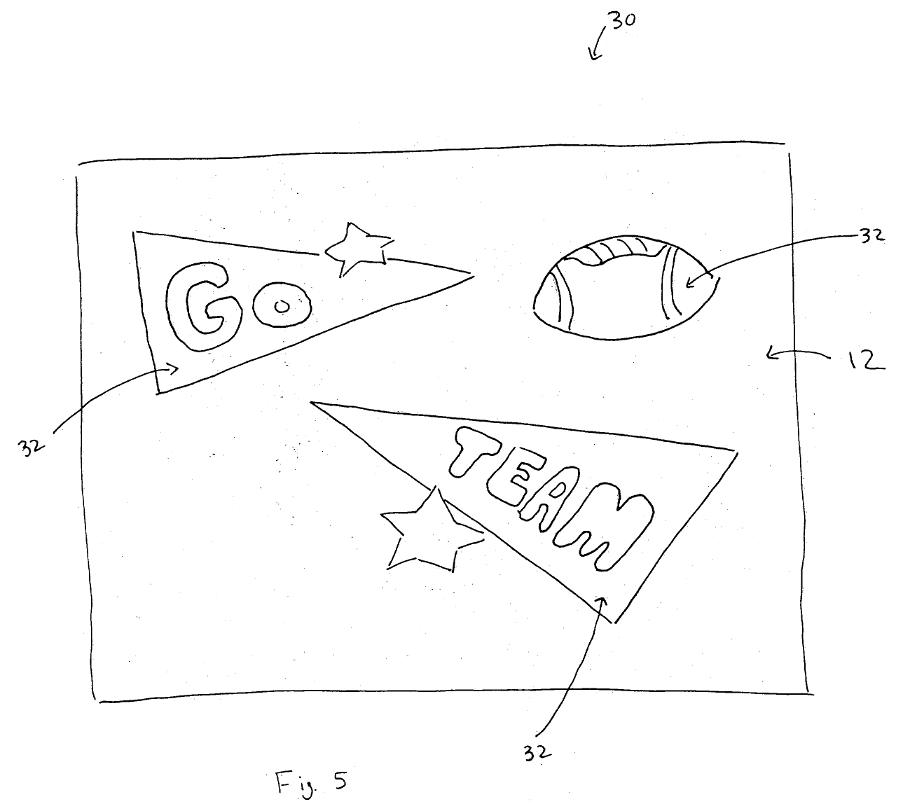

FIG. 5 illustrates an alternative use of the decorative display system according to the present invention. In FIG. 5, a display system 30 according to the present invention has been customized by affixing stickers 32 to the foam mat 12. The customized display may be placed on any ferrous surface, including but not limited to the door panel of a vehicle or on the wall of a prefabricated home. It is appreciated that customization of the display is not limited to the use of stickers, but may be accomplished by any decorative means, including paint, ink, etc.

In a manner similar to that depicted in FIG. 5, a picture or photograph may be displayed by adhering a picture to the foam mat surface of a decorative display system according to the present invention. The display could be further customized by any means desired, by the user. FIG. 5 shows a mat 28 that has been customized through stickers 30 and other decorations, which can be placed on the door panel of a vehicle or on the wall of a pre-fabricated home, etc.

It is appreciated that the decorative display system of the invention may be. of different configurations. For example, the top foam surface may be of various colors. Moreover, the dimensions and/or shape of the system may vary. While the display system may be of a width that is approximately 229 mm (9 inches) and a height that is approximately 305 mm (12 inches), the size may range from about 25 mm (1 inch) wide and 25 mm (1 inch) high to about 279 mm (11 inches) wide. Larger display systems are also contemplated. Additionally, the present invention may be formed into any desired shape. While, in the preferred embodiments, the decorative display system is a rectangle, the decorative display system may be a circle, triangle, hexagon, octagon and the like. That is the display system, as provided to a user, i.e., the combination of the foam mat and a magnetic backing before a user undertakes customization of the display system, may be any shape.

Thus, the foam mat with magnetic backing of the invention provides a magnet that may be readily customized and personalized by a consumer.

As is apparent from the foregoing detailed description, a method of manufacturing a decorative display system 10, having a foam mat with a magnetic backing is also provided. The method includes the steps of providing a foam sheet 12 that may be EVA foam, as described above. An adhesive is applied to one side of the foam sheet 12 and the sheet 12 is cut to be over or greater than the final dimensions of the display system 10. For example, a display 10 that is of a final size that is approximately 229 mm (9 inches) wide by approximately 305 mm (12 inches) high, may have a foam sheet 12 that is cut to about 239 mm wide by about 315 mm wide.

The side of the oversized foam sheet having the adhesive is placed in contact with a magnetic rubber sheet 14, thereby causing the foam sheet 12 to adhere to the magnetic backing 14. The mat to which the magnetic sheet has been adhered is then trimmed to a finished size, for example, 229 mm (9 inches) wide by approximately 305 mm (12 inches) high, yielding the finished decorative display system having a foam mat with magnetic backing.

The invention has been described with reference to preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A manipulable decorative display system comprising:
a first pliable layer having a first surface and a second surface formed from a resilient, but pliable foam material, and
a second magnetic layer having a first surface and a second surface formed from a rubberized sheet containing magnetic particles,
the first or second surface of the magnetic second layer is adhered to the first or second surface of the pliable first surface, providing a foam surface that is receptive to decorative materials and a magnetic surface below the foam layer,
wherein the magnetic second layer has a thickness sufficient for the decorative display system to be sufficiently pliability such that an end user may manipulate the display system to a desired shape or configuration.

2. The manipulable magnetic display system of claim 1, wherein the foam material is receptive to paint, ink, and adhesives for use in the decorative arts.

3. The manipulable magnetic display system of claim 1, wherein the first layer has a thickness of about 0.5 mm to about 6.0 mm.

4. The manipulable magnetic display system of claim 1, wherein the magnetic second layer has a thickness of about 0.1 mm to about 0.5 mm.

5. A decorative display system comprising:
a pliable foam mat not having a thickness of about 0.5 mm to about 5.0 mm, and
a magnetic sheet attached to the foam mat, the magnetic sheet being formed of a rubberized sheet containing magnetic particles, and having a thickness of about 0.1 mm to about 0.5 mm.

6. The decorative display system of claim 5, wherein the foam mat has a thickness of about 2.0 mm.

7. The decorative display system of claim 5, wherein the magnetic sheet has a thickness of about 0.2 mm to about 0.3 mm.

8. A method of manufacturing a manipulable magnetic display system comprising providing a foam sheet having a first surface and a second surface, applying an adhesive to one of the foam sheet's first or second surface, providing a rubberized sheet containing magnetic particles, the rubberized sheet having a first surface and a second surface, and adhering the rubberized sheet to the foam sheet by contacting one of the rubberized sheet's first or second surface with surface of the foam sheet to which the adhesive has been applied.

9. The method of claim 5, wherein the foam sheet has dimensions greater than that of the final manipulable magnetic display system.

10. The method of claim 6, further comprising cutting the manipulable magnetic display system to a finished desired size.
